(19) United States
(12) Patent Application Publication
(10) Pub. No.: US 2016/0027297 A1
(43) Pub. Date: Jan. 28, 2016

(54) Smart Slide-On-Strap Device, Smart Strap and Processing Circuit of Smart Strap

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/789,719

(22) Filed: Jul. 1, 2015

(30) Foreign Application Priority Data
Jul. 25, 2014 (CN) 201410360067.6
Jul. 25, 2014 (CN) 201410360879.0
Jul. 25, 2014 (CN) 201410361592.X

(51) Int. Cl. G08C 17/02; A45F 5/00

(52) U.S. Cl. CPC G08C 17/02; A45F 5/00; A45F 2005/002; A45F 2005/008; G08C 2201/30; G08C 2201/93

(57) ABSTRACT

A smart slide-on-strap device comprises a body, a wireless module, a processing unit and at least one slide-on-strap touch-sensing structure. The body has a strap. The wireless module is disposed on the body. The processing unit is coupled to the wireless module. The slide-on-strap touch-sensing structure is disposed on the strap and coupled to the processing unit. The slide-on-strap touch-sensing structure senses at least one trigger event to remotely control an electronic device having a display. The processing unit produces a corresponding operation instruction according to the user's touch input operation. The wireless module transmits the operation instruction to another electronic device having a display to remotely control the electronic device, and the function possessed by the smart slide-on-strap device is enhanced.

### CROSS REFERENCE TO RELATED APPLICATIONS

This Non-provisional application claims priority under 35 U.S.C. §119(a) on Patent Application No(s). 201410360879.0, 201410360067.6 and 201410361592.X filed in People's Republic of China on Jul. 25, 2014, the entire contents of which are hereby incorporated by reference

### BACKGROUND

1. Technical Field

The invention relates to a smart slide-on-strap device and a smart strap, and more particularly to a smart wearable slide-on-strap device and a smart strap.

2. Related Art

With the progress of technologies, various information devices having communication functions are continuously innovated, such as mobile phones, tablet computers, ultra-thin notebook computers, satellite navigation devices or other hand-held communication devices. At present, due to advances in technology, the processors are continuously developed to be a smaller size and higher performance. Thus some wearable devices having much smaller sizes than other communication devices are also developed to have communication functions and other functions.

Accordingly, smart wearable device products, such as smart watches, smart bracelets or the like, have been developed and come out. In comparison with the conventional watch, the smart watch further comprises a positioning module capable of recording a position of the smart watch or the smart bracelet and a transmission module capable of communicating with other electronic devices to obtain the activity records of the user while wearing the smart watch or the smart bracelet. However, either the smart watch or the smart bracelet has the small size, and thus has the restricted functions.

For example, although the current smart watch and smart bracelet can communicate with other electronic devices, they are only used in power transmission or data transmission to charge the smart watch and the smart bracelet. Or to transmit the activity records of the users recorded by the smart watch and the smart bracelet, and there are no more other applications provided to other electronic devices. At present, in addition to the restricted functions, the overall appearance of the wearable smart device further needs to be broken through. In details, most input functions of the wearable smart device are executed through physical buttons, and the physical buttons need to be additionally disposed on the surface of the smart wearable device, thereby deteriorating the overall integrity and beauty.

### SUMMARY

An aspect of the invention is to provide a smart slide-on-strap device, a smart strap and a processing circuit thereof to enhance the functions possessed by the smart slide-on-strap device and the smart strap, and to enhance the overall integrity of the outlook of each of the smart slide-on-strap device and the smart strap. In details, the smart slide-on-strap device and the smart strap have the slide-on-strap touch-sensing structure, which has the touch input function and is disposed on the strap, and a processing unit produces the corresponding operation instruction according to the user's input operation. A wireless module transmits the operation instruction to another electronic device having a display to remotely control the targeted electronic device, and to enhance the functions possessed by the smart slide-on-strap device and the smart strap. Meanwhile, the design of the slide-on-strap touch-sensing structure can need no more physical buttons, therefore, the overall integrity of the outlook of the slide-on-strap touch-sensing structure is upgraded.

A smart slide-on-strap device comprises a body, a wireless module, a processing unit and at least one slide-on-strap touch-sensing structure. The body has a strap. The wireless module is disposed on the body. The processing unit is coupled to the wireless module. The slide-on-strap touch-sensing structure is not only disposed on the strap, but also coupled to the processing unit, and senses at least one trigger event to remotely control an electronic device having a display.

A smart strap comprises a strap, a wireless module, a processing unit and at least one slide-on-strap touch-sensing structure. The wireless module is disposed on the strap. The processing unit is coupled to the wireless module. The slide-on-strap touch-sensing structure is not only disposed on the strap, but also coupled to the processing unit, and senses at least one trigger event to remotely control an electronic device having a display.

A processing circuit of a smart strap is provided. The smart strap comprises a strap and a wireless module. The processing circuit is coupled to the wireless module. The processing circuit comprises a memory unit, at least one slide-on-strap touch-sensing structure and a processing unit. The memory unit stores at least one operation instruction. The slide-on-strap touch-sensing structure is disposed on the strap and senses at least one trigger event. The processing unit is coupled to the memory unit and the slide-on-strap touch-sensing structure, and receives a signal, generated according to the trigger event by the slide-on-strap touch-sensing structure, and correspondingly produces the operation instruction to remotely control an electronic device having a display.

In one embodiment, the smart slide-on-strap device comprises a smart bracelet, a smart watch or a smart remote controller.

In one embodiment, the strap comprises a watchband of the smart watch or a strap of the smart bracelet.

In one embodiment, the processing unit receives a signal generated according to the trigger event and correspondingly produces an operation instruction.

In one embodiment, the wireless module receives and transmits the operation instruction to the electronic device having a display.

In one embodiment, the trigger event comprises a trigger quantity, a trigger quantity distribution, a trigger morphology (which can refer to trigger appearance), a trigger time, a trigger frequency or a trigger location (which can refer to trigger position).

In one embodiment, if the trigger event occurs on the slide-on-strap touch-sensing structure, the trigger time is longer than or equal to a predetermined time, and a trigger track corresponds to one direction, then the processing unit produces an operation instruction for increasing or decreasing a volume.

In one embodiment, if the trigger event occurs on the slide-on-strap touch-sensing structure, the trigger time is longer than or equal to a predetermined time, and a trigger track corresponds to one direction, then the processing unit produces an operation instruction for increasing or decreasing a playback speed.

In one embodiment, if the trigger event occurs on the slide-on-strap touch-sensing structure, the trigger track comprises multiple trigger tracks having more than one direction, then the processing unit produces an operation instruction of one-dimensional screen scrolling, wherein a direction of the one-dimensional screen scrolling is the same with the direction of multiple trigger tracks.

In one embodiment, if the trigger frequency of the trigger event conforms to a booting condition, then the processing unit produces an operation instruction for booting.

In one embodiment, the wireless module comprises an infrared module, a bluetooth module, a ZigBee module, a radio frequency module or a near-field communication module.

In one embodiment, the near-field communication module comprises a user identification key automatically linking to the electronic device having a display through the wireless module.

In one embodiment, the wireless module has a wireless communication chip and an antenna, the wireless communication chip is electrically connected to the processing unit, and the antenna is disposed on the body or the slide-on-strap touch-sensing structure.

In one embodiment, the wireless module synchronously or asynchronously transmits a wireless signal and receives wireless charging energy of a wireless charging device.

In one embodiment, the wireless charging energy comes from a wireless access point, a display, a television or a monitor.

In one embodiment, the slide-on-strap touch-sensing structure comprises a driving circuit and a sensing circuit, the driving circuit is disposed inside the strap, and the sensing circuit is disposed on an outer surface of the strap.

In one embodiment, a portion of the sensing circuit on the outer surface of the strap has a protrusion, and the strap further comprises a protection layer covering the protrusion.

In summary, the smart slide-on-strap device and the smart strap provided for a user to perform the touch input by touching the slide-on-strap touch-sensing structure disposed on the strap. In addition, because the memory unit in the processing circuit of the smart strap stores the operation instruction, and the slide-on-strap touch-sensing structure is disposed on the strap, the user can perform the touch operation on the slide-on-strap touch-sensing structure. Next, the processing unit produces the corresponding operation instruction, and the wireless module transmits the operation instruction to another electronic device having the display to remotely control the electronic device. In other words, the smart slide-on-strap device and the smart strap may be used as the smart remote controller to enhance the functions possessed by the smart slide-on-strap device and the smart strap. The design of the slide-on-strap touch-sensing structure may also need no more physical buttons, and the overall integrity of the outlook of the slide-on-strap touch-sensing structure can be upgraded. In addition, because the element of performing the touch operation is totally the slide-on-strap touch-sensing structure, the conventional physical button can be replaced, and the overall integrity and beauty of the outlook of the smart slide-on-strap device can be enhanced, and higher quality and more wonderful user experience can be implemented.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic view showing a smart slide-on-strap device according to a first embodiment of the invention;

FIG. 2 is a schematic block diagram showing the smart slide-on-strap device of FIG. 1;

FIG. 3 is a schematic view showing another example of the smart slide-on-strap device of the first embodiment;

FIG. 4 is a schematic view showing the application architecture of the smart slide-on-strap device of FIG. 1;

FIGS. 5A and 5B are schematic views showing operations of the smart slide-on-strap device of FIG. 1;

FIGS. 6A and 6B are schematic views showing operations of the smart slide-on-strap device of FIG. 1;

FIG. 7 is a schematic view showing a smart strap according to a second embodiment of the invention;

FIG. 8 is a schematic block diagram showing the smart strap of FIG. 7;

FIG. 9 is a schematic view showing another example of the smart strap of the second embodiment;

FIG. 10 is a schematic view showing operations of the smart strap of FIG. 7;

FIGS. 11A and 11B are schematic views showing operations of the smart strap of FIG. 7;

FIGS. 12A and 12B are other schematic views showing operations of the smart strap of FIG. 7;

FIG. 13 is a schematic view showing a processing circuit of a smart strap applied to the smart strap according to a third embodiment of the invention;

FIG. 14 is a schematic block diagram showing the processing circuit and the smart strap of FIG. 13; and

FIG. 15 is a schematic view showing the processing circuit of the smart strap of the third embodiment applied to another example of the smart strap.

### DETAILED DESCRIPTION OF THE INVENTION

The embodiments of the invention will be apparent from the following detailed description, which proceeds with reference to the accompanying drawings, wherein the same references relate to the same elements.

In the first embodiment, the smart slide-on-strap device is described as an example, wherein the smart slide-on-strap device of this embodiment is applied to a wearable device, which may be directly worn by the user, and may be a smart bracelet, a smart watch or the like. Of course, the smart slide-on-strap device of this embodiment may also be a detachable wearable device, such as a device worn in the form of a necklace or a finger ring. However, it is not limited thereto. Thus, the smart slide-on-strap device of this embodiment also relates to an application of a small wearable electronic device with displaying and inputting functions. The “slide-on-strap” smart device of this embodiment is a device having a strap, such as a watchband of a watch or a strap of a bracelet, wherein a touch input can be performed on the strap. Next, the smart slide-on-strap devices of the following embodiments are described as the smart watch, the smart bracelet and the smart necklace serving for examples.

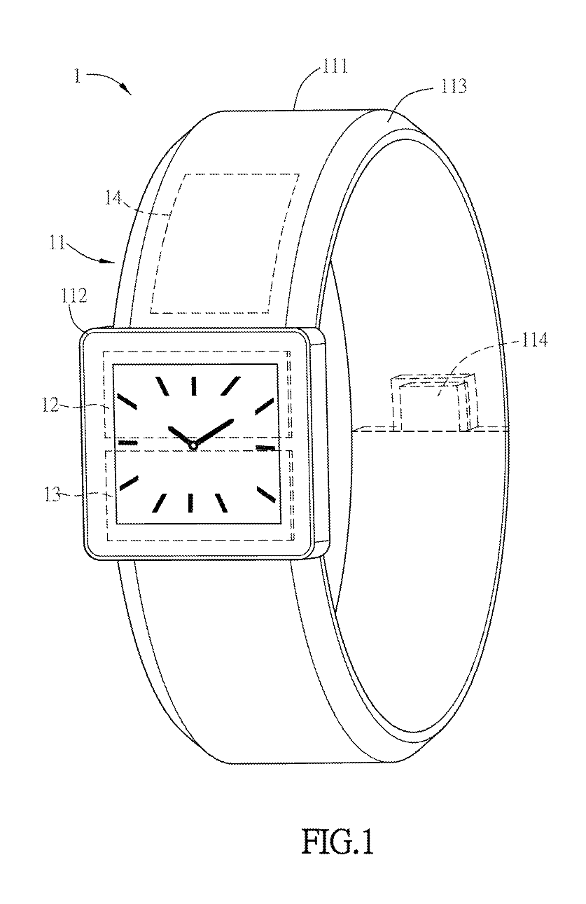

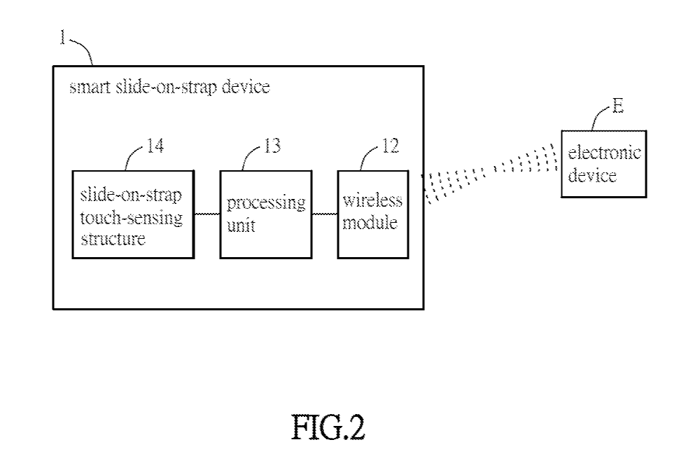

FIG. 1 is a schematic view showing a smart slide-on-strap device according to a first embodiment of the invention. FIG. 2 is a schematic block diagram showing the smart slide-on-strap device of FIG. 1. The smart slide-on-strap device 1 of this embodiment is a smart watch to be described as an example, as shown in FIGS. 1 and 2. Additionally, elements of the smart slide-on-strap device 1 of this embodiment may be implemented by the combination of the hardware, software or firmware of one or multiple signal processing and/or integrated circuits.

The smart slide-on-strap device 1 of this embodiment comprises a body 11, a wireless module 12, a processing unit 13 and at least one slide-on-strap touch-sensing structure 14. As mentioned hereinabove, the smart slide-on-strap device 1 of this embodiment is a smart watch described as an example. The body 11 has a strap 111 and a housing 112. The strap 111 is connected to the housing 112, and is a portion that may be worn by the user. In other embodiments, the strap 111 is detachably connected to the housing 112, but it is not limited to the connection form. In details, the strap 111 of this embodiment may be a watchband of a smart watch, and may also be a strap of a smart bracelet or the portion of the necklace chain or a circle of the finger ring in other embodiments, and it is not limited thereto. The length of the strap 111 is substantially equal to that of the hand circumference or foot circumference, so that the strap 111 can be worn by the user. Besides, the length of the strap 111 may also be adjustable so that the adjustment can be made according to the hand circumferences or foot circumferences for different user's requirement.

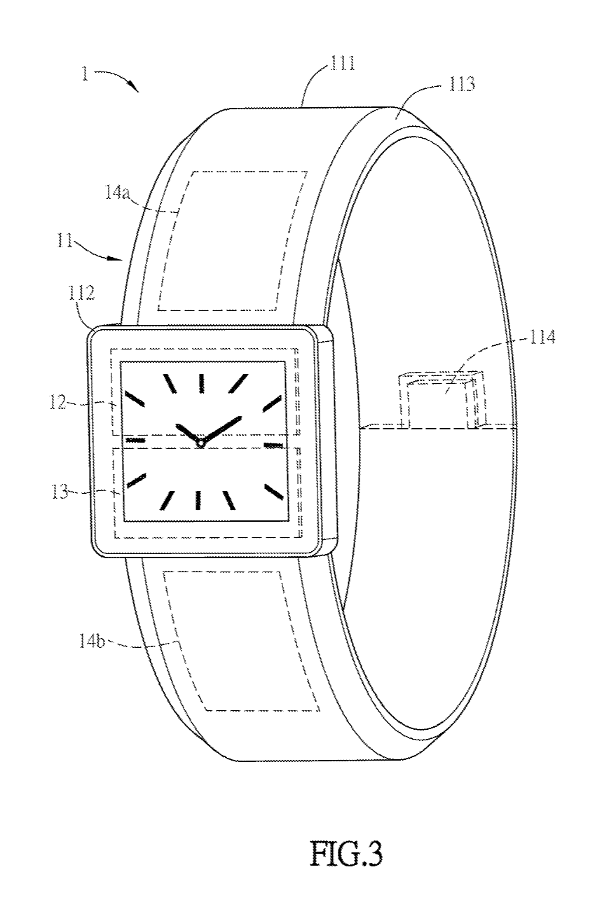

In addition, the wireless module 12 and the processing unit 13 of this embodiment are disposed on the body 11, and may be disposed on the strap 111 of the body 11 or inside the housing 112, but they are not limited thereto. The wireless module 12 and the processing unit 13 may be disposed inside the housing 112 of the body 11, and the wireless module 12 and the processing unit 13 are coupled to each other. The slide-on-strap touch-sensing structure 14 is disposed on the strap 111 and disposed on one side of the housing 112. In other embodiments, the smart slide-on-strap device 1 may also have two slide-on-strap touch-sensing structures 14a and 14b, and are respectively disposed on two opposite sides of the strap 111 corresponding to the housing 112, as shown in FIG. 3. FIG. 3 is a schematic view showing another example of the smart slide-on-strap device of the first embodiment. It is noted that because the difference between the smart slide-on-strap devices 1 of FIGS. 1 and 3 only exists in the number of the slide-on-strap touch-sensing structures 14, so the symbols thereof are adopted. In details, the slide-on-strap touch-sensing structures 14a and 14b of this embodiment are respectively disposed on top and bottom sides of the housing 112. In other embodiments, the slide-on-strap touch-sensing structures 14a and 14b may also be disposed on side edges 113 of the body 11 to form that the slide-on-strap touch-sensing structures 14a and 14b are disposed on the left and right sides of the display P. They may also be concurrently distributed on the top, bottom, left and right sides of the display P to enlarge the area where the user can execute the operation. However, they are not limited thereto.

The slide-on-strap touch-sensing structure 14 of this embodiment is a capacitive touch-sensing structure. When a conductor, such as a user's finger, touches the slide-on-strap touch-sensing structure 14, the slide-on-strap touch-sensing structure 14 at the contact position induces the capacitance change to generate the corresponding signal. In addition, the slide-on-strap touch-sensing structure 14 may comprise a driving circuit and a sensing circuit (Tx and Rx, which are well known in the art but not depicted in the drawing), and the material thereof may be an electro-conductive layer (for example, a transparent electro-conductive layer, such as indium tin oxide (ITO), indium zinc oxide, fluorine doped tin oxide, aluminum doped zinc oxide (AZO) or gallium doped zinc oxide may be adopted), a nano wire layer, graphene, or a metal mesh. However, it is not limited thereto.

The driving circuit is disposed inside the strap 111, the sensing circuit is disposed on an outer surface of the strap 111, a portion of the sensing circuit has a protrusion on the outer surface of the strap 111, and the strap 111 may further comprise a protection layer for covering the protrusion and thus protecting the sensing circuit. In addition, the user can obtain the position of the slide-on-strap touch-sensing structure 14 by touching the protrusion. In other words, indicating the position of the slide-on-strap touch-sensing structure 14 can be implemented by the sensing circuit of the protrusion. In other embodiments, the protrusion may further be designed to have a designate shape, such as an arrow shape or the like, for instructing the user to execute the touch operation.

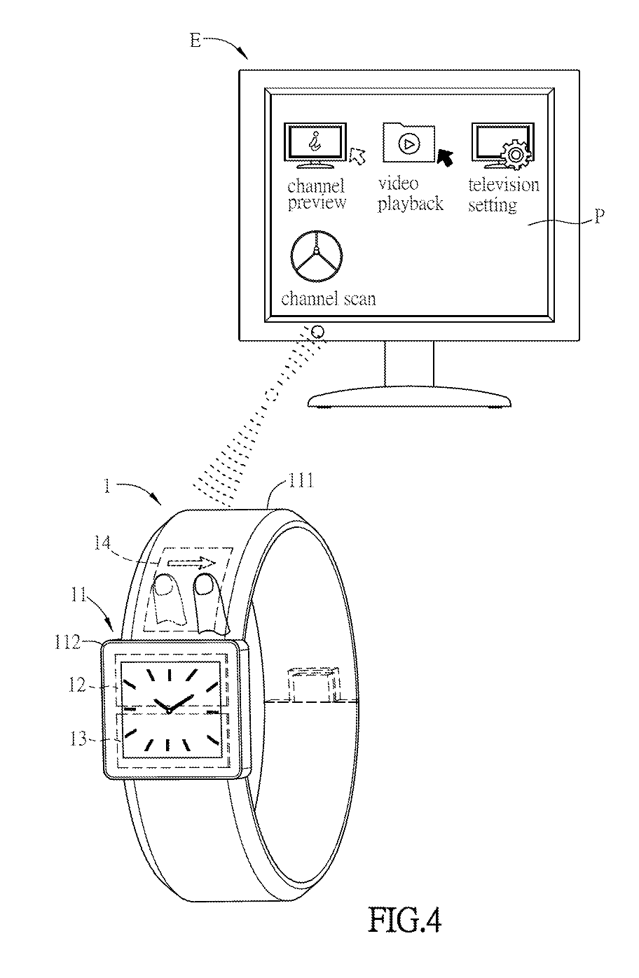

In addition, the wireless module 12 may comprise an infrared module, a bluetooth module, a ZigBee module, a radio frequency module or a near-field communication module. FIG. 4 is a schematic view showing the application architecture of the smart slide-on-strap device of FIG. 1. Referring to FIGS. 2 and 4 concurrently, the smart slide-on-strap device 1 of this embodiment may communicate with another electronic device E via the wireless module 12. The electronic device E may be an electronic device E having the display P, which may be a display of an all-in-one computer, a display of a desktop computer, a display of a notebook computer or a display of a tablet computer. However, it is not limited thereto. In details, the wireless module 12 has a wireless communication chip and an antenna. The wireless communication chip is coupled to the processing unit 13, and the antenna may be disposed on the slide-on-strap touch-sensing structure 14. However, they are not limited thereto. In other embodiments, there may be multiple wireless modules 12 for performing short-distance data transmission with other electronic devices, or performing data transmission via the telecommunication or network signals.

In one embodiment, if the wireless module 12 is the near-field communication module, then the near-field communication module may further comprise a user identification key, and automatically links the user identification key to the electronic device E having the display P through the wireless module 12 for the purpose of identification to restrict or manage the user who holds the smart slide-on-strap device 1 in manipulating the electronic device E. The electronic device E of this embodiment may be an ordinary home appliance, and disposed in the house environment. Alternatively, the identification functions of the electronic device E may be utilized so that the corresponding electronic device E is disposed in a vehicle, a bank or at a doorway. However, it is not limited thereto.

The processing unit 13 is coupled to the wireless module 12 and the slide-on-strap touch-sensing structure 14. The processing unit 13 may receive the signal generated when the slide-on-strap touch-sensing structure 14 is touched, produce the corresponding operation instruction, transmit the corresponding operation instruction to the wireless module 12, and then communicate with the electronic device E through the wireless module 12 to remotely control the electronic device E having the display P. The processing unit 13 of this embodiment is a central processing unit (CPU) in one example. In detail, the slide-on-strap touch-sensing structure 14 is coupled to the processing unit 13 to permit the user to perform the touch operation on the slide-on-strap touch-sensing structure 14 by fingers, for example, and to enable the display P of the electronic device E to display the corresponding operation instruction according to the operating gesture of the user (or referred to the hand gesture or posture) through the processing unit 13 and the wireless module 12 in order to interact with the graphic user interface displayed on the display P.

For example, when the user's finger slides on the slide-on-strap touch-sensing structure 14, the display P also has s a corresponding cursor (e.g., in the shape of an arrow or a hand) sliding at the corresponding position, as shown in FIG. 4. In addition, the interaction with the graphic user interface may be, for example, that the user adopts the finger to touch on the slide-on-strap touch-sensing structure 14 to perform the operation of tapping, volume adjusting or playback speed adjusting. For example, when the user's finger taps on the slide-on-strap touch-sensing structure 14, the display P executes the object corresponding to the position information, and can execute the object, displayed on the display P, through the direct control on the slide-on-strap touch-sensing structure 14. Thus, the object of shadeless touch can be implemented. Herein, the so-called “touch” may comprise the operation hand gesture or the operation gesture or other posture, such as tapping once or tapping multiple times, sliding once or sliding multiple times (e.g., sliding from left to right, sliding from right to left, sliding upward or downward), the sequential tapping of multiple fingers, sliding of multiple fingers, or the like.

In details, each touch operation can make the slide-on-strap touch-sensing structure 14 sense at least one trigger event, and transmits a signal, induced by the trigger event, to the processing unit 13, which analyzes the signal and processes the signal to convert a corresponding operation instruction. Next, the wireless module 12 receives the operation instruction from the processing unit 13, and transmits the operation instruction to the electronic device E having the display P, so that the processing unit of the electronic device E can correspondingly execute the operation instruction. It means the smart slide-on-strap device 1 can remotely control the electronic device E, and control contents displayed by the display P. The processing unit 13 of this embodiment may be constituted by a single processing chip or multiple processing chips, and can analyze the trigger event sensed by the slide-on-strap touch-sensing structure 14. The trigger event comprises a trigger quantity, a trigger quantity distribution, a trigger morphology (which can refer to trigger appearance), a trigger time, a trigger frequency or a trigger location (which can refer to trigger position). Operation instructions corresponding to various trigger events may be preset when the smart slide-on-strap device 1 is shipped out, and may also be modified by the users according to their different using habits.

The processing unit 13 can produce the corresponding operation instruction according to the trigger time, trigger track or trigger frequency of the trigger event, wherein the trigger time is the time length during which the user's finger touches the slide-on-strap touch-sensing structure 14. For example, a short press (with the short trigger time) corresponds to a selecting operation, and a long press (with the long trigger time) corresponds to a confirmation operation. The trigger track represents a track path of a touch operation. Corresponding operation instructions may be produced according to the track paths by way of setting. The trigger frequency represents the frequency of the touch operations in a short time, and represents the user's tapping frequency on the slide-on-strap touch-sensing structure 14. The operation instruction may be correspondingly produced according to the designate tapping frequency by way of setting. Various embodiments will be described in the following.

In one embodiment, the trigger frequency of the trigger event conforms to a booting condition. That is, when the user's clicking frequency on the slide-on-strap touch-sensing structure 14 conforms to a booting condition, the processing unit 13 can correspondingly produce a booting operation instruction, and transmit the booting operation instruction to the electronic device E through the wireless module 12 so that the power is turned on and the display P displays an image. In other words, the user can set the click operation with the designate frequency as the booting condition by oneself When the processing unit 13 receives the trigger event conforming to the booting condition, the electronic device E can be remotely controlled to execute the booting operation instruction. In other embodiments, it is also possible to set the following condition, in which when the trigger event occurs on the slide-on-strap touch-sensing structure 14 and the touch time (trigger time) is longer than or equal to a preset predetermined time, such as 5 seconds, the processing unit 13 can correspondingly produce the booting operation instruction, and remotely control the electronic device E to execute the booting operation instruction by the wireless module 12.

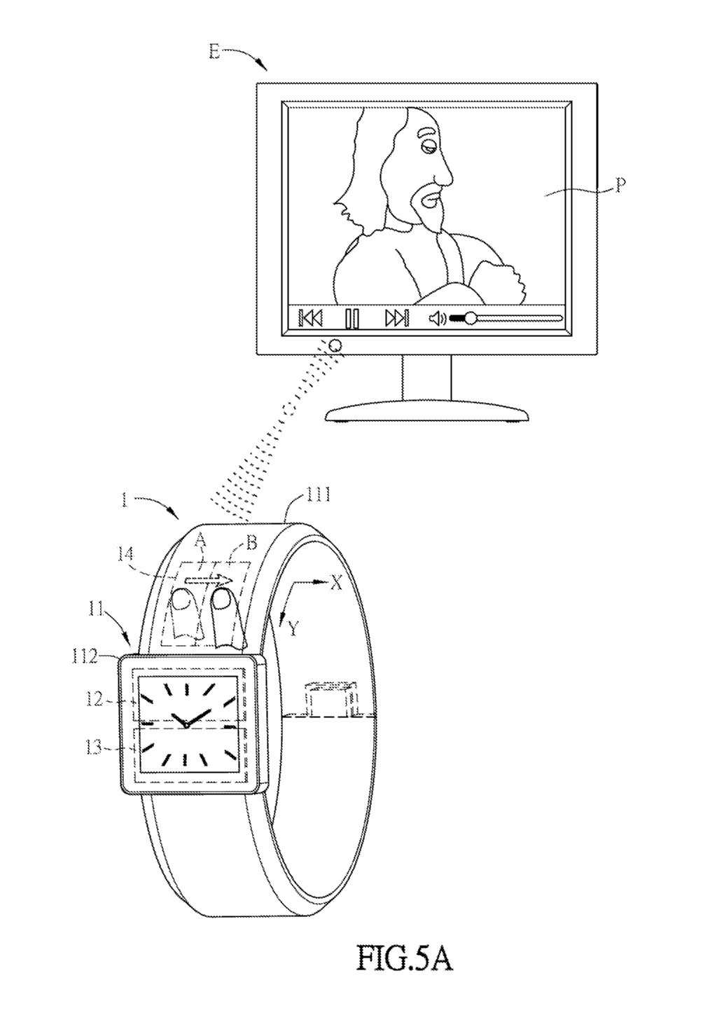

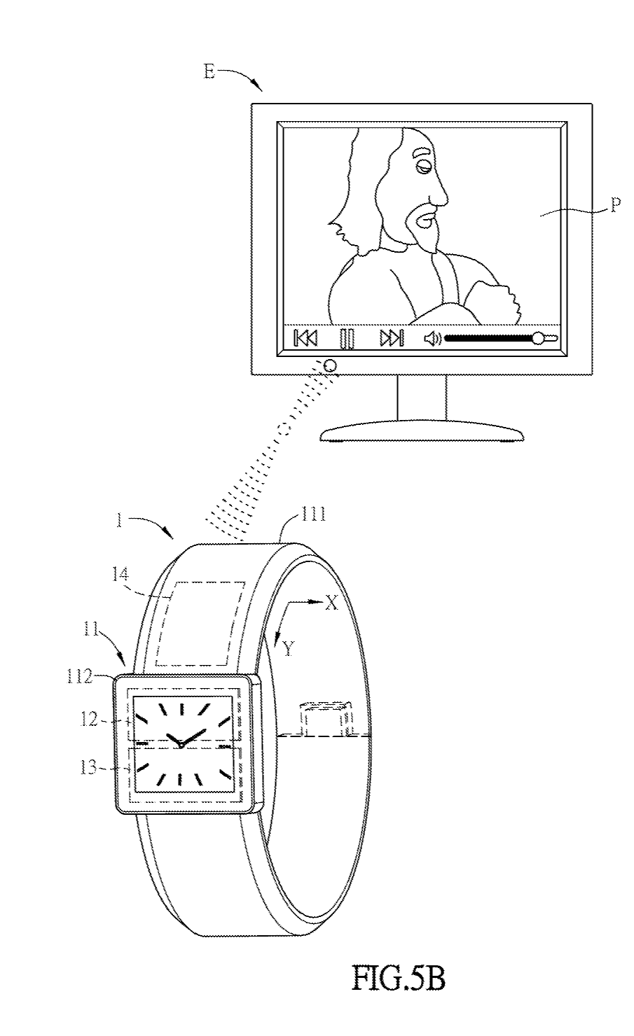

FIGS. 5A and 5B are schematic views showing operations of the smart slide-on-strap device of FIG. 1. Referring to FIGS. 2, 5A and 5B. In one embodiment, it is also possible to set the following condition. The processing unit 13 produces the operation instruction for increasing or decreasing the volume and remotely controls the electronic device E to execute the operation instruction for increasing or decreasing the volume via the wireless module 12 after the electronic device E booting, the trigger event occurs on the slide-on-strap touch-sensing structure 14, the trigger time is longer than or equal to the preset predetermined time, which may be the same as (5 seconds) or different from (e.g., 1 second) that of the above-mentioned embodiment, and the trigger track is in one direction (i.e., the touch track path is substantially a straight line in one direction). In this embodiment, the trigger track sliding from the region A (left) to the region B (right) in the X direction is defined as the operation gesture for increasing the volume; and the trigger track sliding from the region B (right) to the region A (left) in the X direction is defined as the operation gesture for decreasing the volume. For example, as shown in FIG. 5A, when the user continuously touches the slide-on-strap touch-sensing structure 14 for 1 second, and the touch trigger track path slides from the region A (left) to the region B (right) in the X direction, the processing unit 13 produces the operation instruction for increasing the volume, and remotely controls the electronic device E to increase the volume via the wireless module 12, as shown in the volume region of FIG. 5B, wherein the black portion is increased. When the touch trigger track is executed on the contrary, the operation instruction means for decreasing the volume.

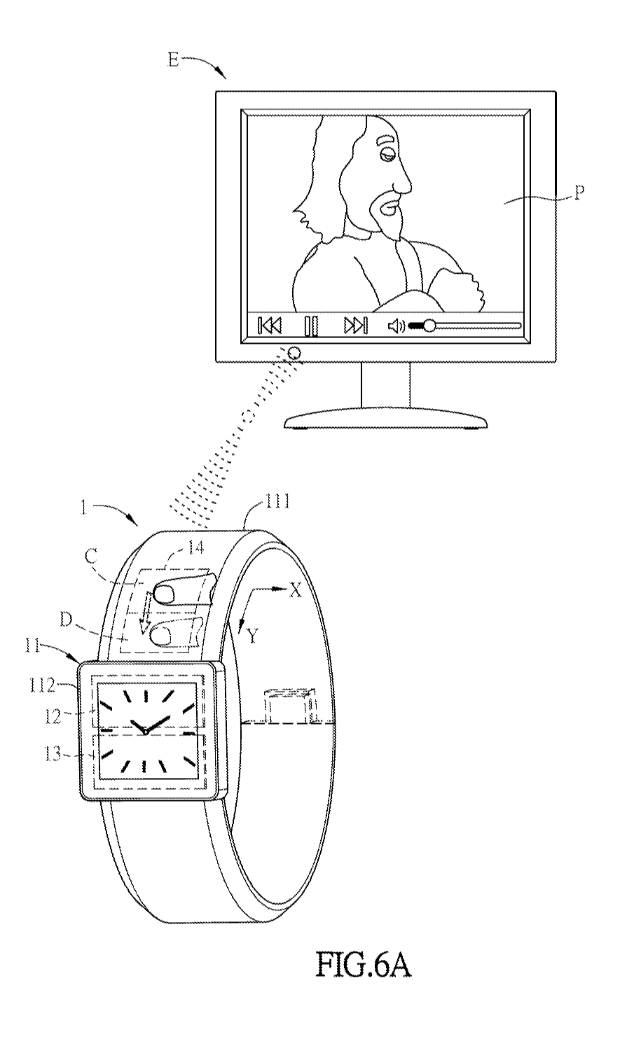

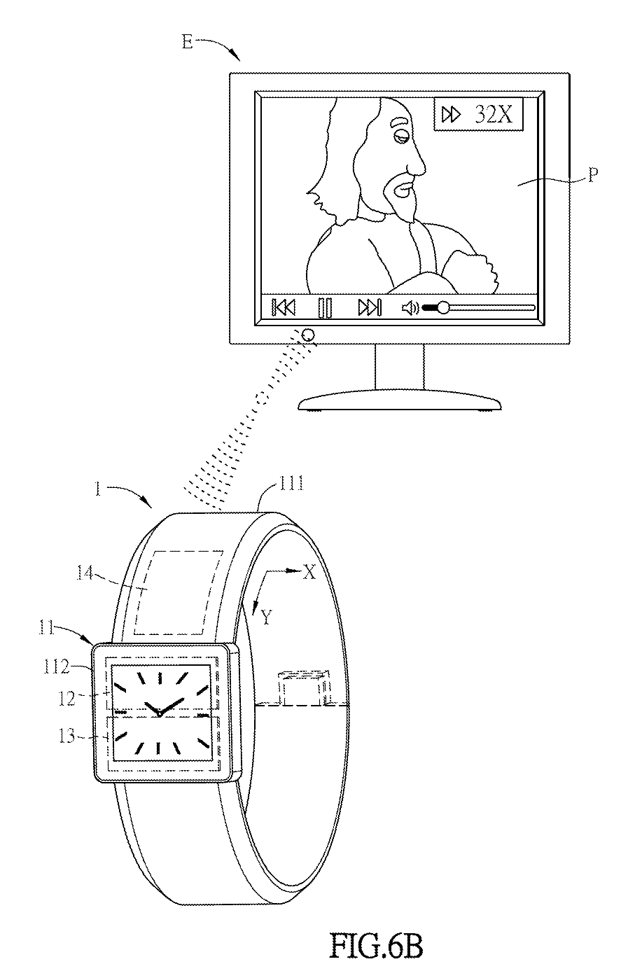

In one embodiment, it is also possible to set the operation instruction for increasing or decreasing the playback speed additionally. FIGS. 6A and 6B are schematic views showing operations of the smart slide-on-strap device of FIG. 1. Referring to FIGS. 2, 6A and 6B. In details, it is possible to set the condition, in which when the user touches the slide-on-strap touch-sensing structure 14 continuously for 1 second, and the touch track path slides from the region C (up) to the region D (down) in the Y direction, such the touch gesture is defined as increasing the playback speed, and the gesture from top to bottom in each operation can be defined as increasing the current playback speed to 2 times of speed (2×). So, the 32 times of speed (32×) of FIG. 6B is set when the user operates the gesture from top to bottom by 5 times (the operations of several times sequentially correspond to 2×, 4×, 8×, 16× and 32×). On the contrary, when the user touches the slide-on-strap touch-sensing structure 14 continuously for 1 second, and the touch track path slides from the region D (down) to the region C (up) in the Y direction; such touch gesture is defined as decreasing the playback speed.

In other embodiments, it is also possible to set the condition, in which when the trigger event occurs on the slide-on-strap touch-sensing structure 14, and the trigger track is composed of multiple single-direction tracks (i.e., the user's fingers touch the slide-on-strap touch-sensing structure 14), the processing unit 13 can correspondingly generate a one-dimensional screen scrolling operation instruction for switching to a next frame. The one-dimensional screen scrolling direction is the same with the direction of the multiple trigger tracks. Such the operation method can be applied to the browsing of document or webpage, or the reading of the mails. However, it is not limited thereto.

In one embodiment, one end of the strap 111 has a signal port 114, which is coupled to the processing unit 13 and can be utilized to data transmission or power transmission to perform charging. In other embodiments, a battery or a wireless charging unit may be provided, wherein the wireless charging unit may be a charging circuit and is disposed on the housing 112 or the strap 111 for wireless charging. In other embodiments, the wireless charging unit may also be disposed on the slide-on-strap touch-sensing structure 14. In details, if the slide-on-strap touch-sensing structure 14 comprises the material of the metal mesh, the nano wire or the graphene, the driving circuit and the sensing circuit of the slide-on-strap touch-sensing structure 14 may further be adopted to perform the wireless power transmission, such as wireless charging. In other embodiments, a wireless signal may be synchronously or asynchronously transmitted and the wireless charging energy of a wireless charging device may be received by the wireless module 12. The wireless charging energy comes from a wireless access point, a display, a television or a monitor for wireless charging. However, it is not limited thereto.

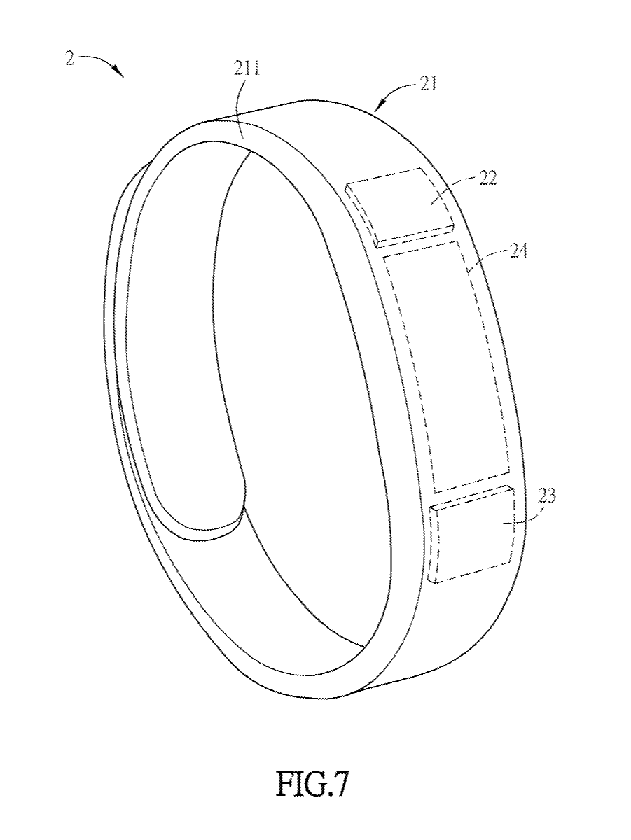

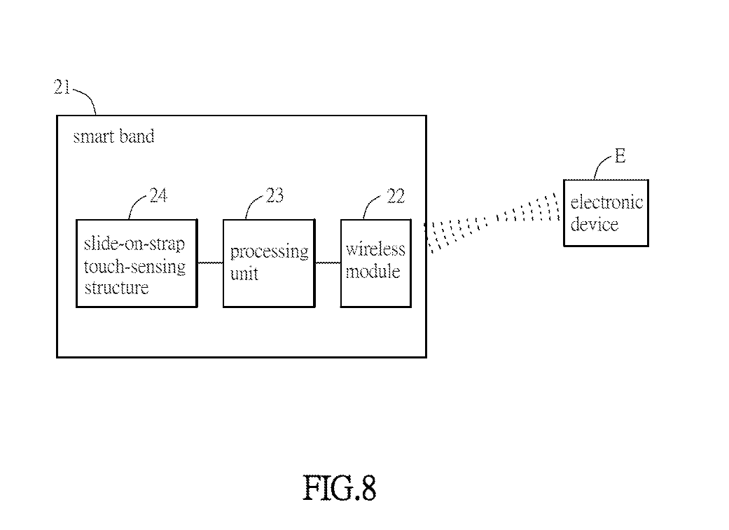

In one embodiment, the smart slide-on-strap device 2 can also be applied to the smart bracelet. FIG. 7 is a schematic view showing a smart strap according to a second embodiment of the invention. FIG. 8 is a schematic block diagram showing the smart strap of FIG. 7. Referring to FIGS. 7 and 8, the smart strap 2 of this embodiment is similarly applied to a wearable device that may be directly worn by the user, and may be implemented by the combination of the hardware, the software and/or the firmware of one or multiple signal processing and/or integrated circuits. The smart strap 2 may be a smart bracelet, a smart watch or the like, for example, and can act as a smart remote controller. In this embodiment, the smart watch is described as an example.

The smart strap 2 of this embodiment comprises a strap 21, a wireless module 22, a processing unit 23 and at least one slide-on-strap touch-sensing structure 24. The difference to the smart slide-on-strap device 1 of the first embodiment is that the body 11 of the smart slide-on-strap device 1 is composed of the strap 111 and the housing 112, while the strap 21 of the smart strap 2 of the second embodiment can be directly worn by the user. In other words, the strap 21 of this embodiment may be directly the strap of the smart bracelet. The length of the strap 21 is substantially equal to that of the hand circumference or the foot circumference, so that the user can wear the strap 21. In addition, the length of the strap 21 may also be adjusted according to the hand circumferences or foot circumferences of different users.

Besides, the wireless module 22 and the processing unit 23 of this embodiment are disposed on the strap 21, and may be disposed inside the strap 21, but they are not limited thereto. The wireless module 22 and the processing unit 23 may be disposed inside the strap 21, and the wireless module 22 and the processing unit 23 are coupled together and detachably or non-detachably disposed inside the strap 21.

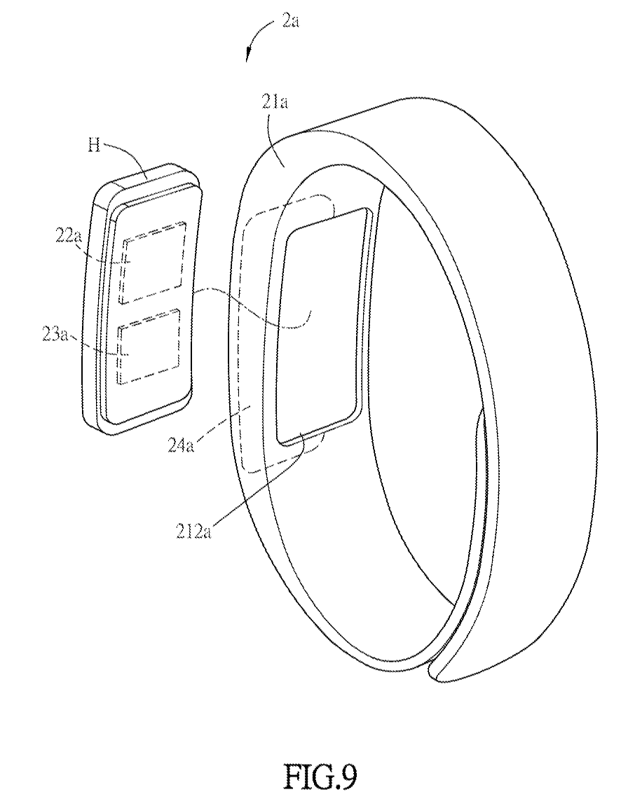

As shown in FIG. 7, the wireless module 22 and the processing unit 23 of this embodiment are non-detachably disposed inside the strap 21. In other embodiments, as shown in FIG. 9, FIG. 9 is a schematic view showing another example of the smart strap of the second embodiment. The smart strap 2a of this embodiment has a wireless module 22a and a processing unit 23a, which may also be detachably disposed inside the strap 21a. In details, the wireless module 22a and the processing unit 23a may be accommodated within a housing H, wherein the strap 21a has a slot 212a, for accommodating the housing H, so that the wireless module 22a and the processing unit 23a are detachably disposed inside the strap 21a.

Referring to FIGS. 7 and 8, the wireless module 22 and the processing unit 23 are coupled to each other, and the slide-on-strap touch-sensing structure 24 is disposed on the strap 21. The slide-on-strap touch-sensing structure 24 of this embodiment is disposed on an outer surface of the strap 21, so that the user can perform the touch input on the slide-on-strap touch-sensing structure 24 on the outer surface of the strap 21. Therefore, the number of the slide-on-strap touch-sensing structure(s) 24 is not limited thereto. In other embodiments, the smart strap 2 may also have multiple slide-on-strap touch-sensing structures 24, which may be disposed at positions on the strap 21 to facilitate the user in performing the touch input, wherein the positions include, for example, the surface of the strap 21, or a side edge 211 of the strap 21, so that the area where the user executes the operation can be enlarged. However, they are not limited thereto.

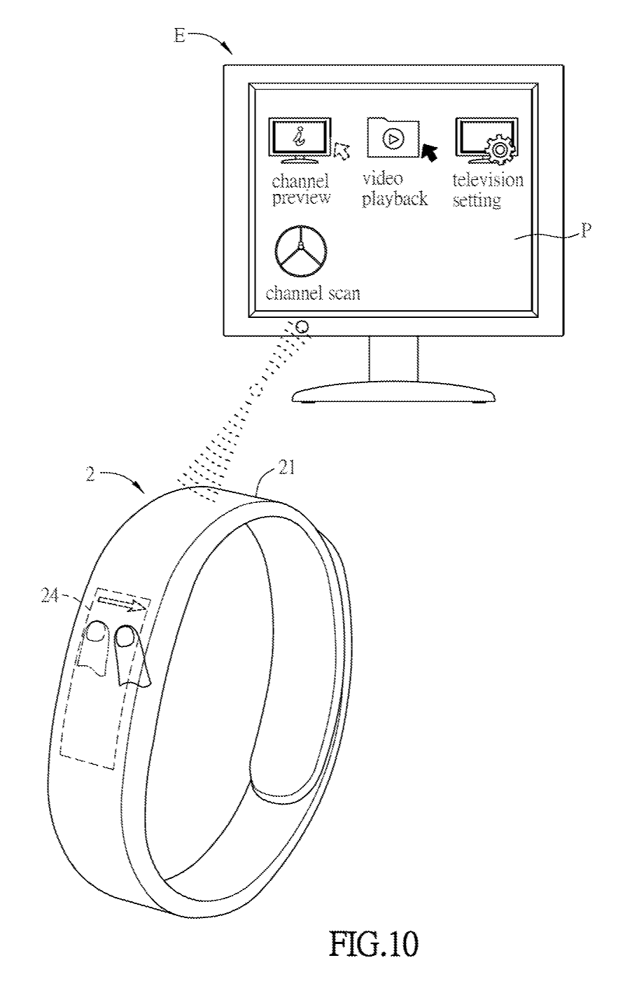

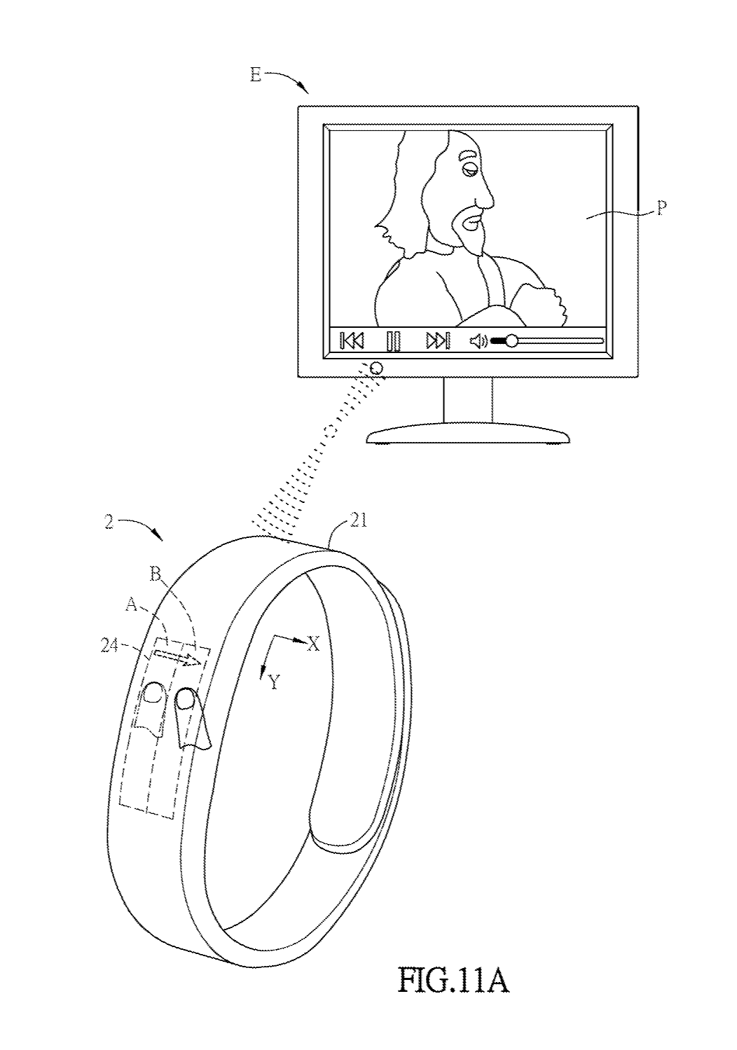

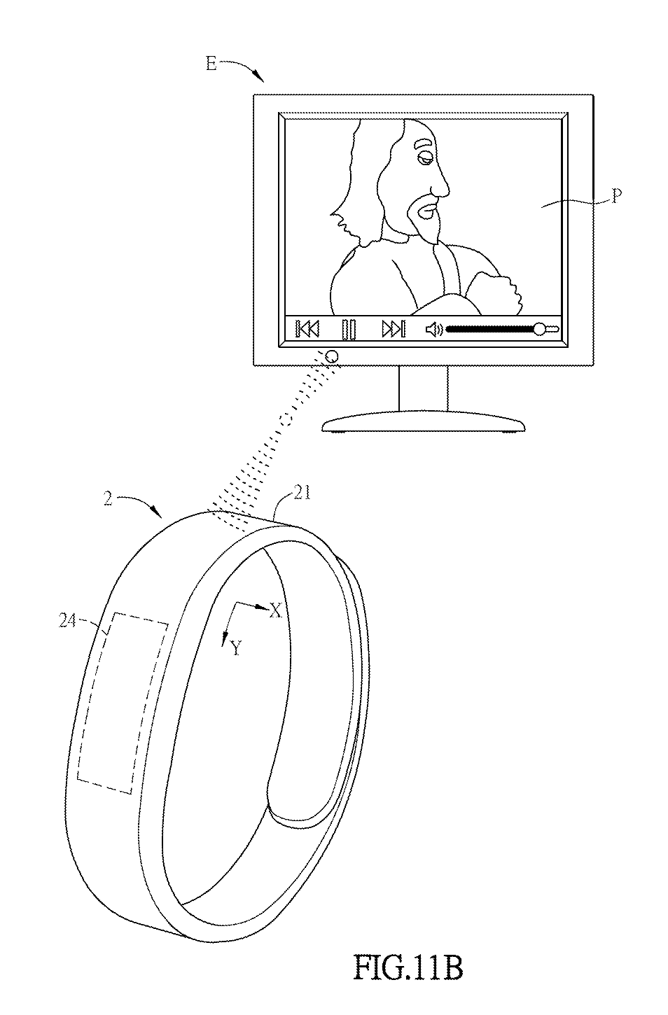

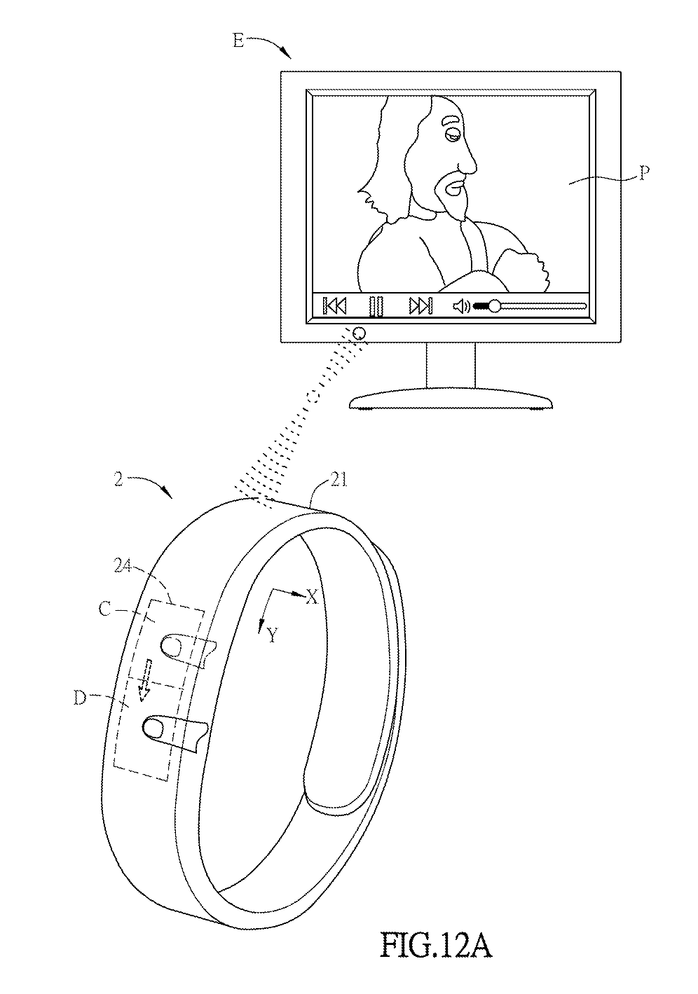

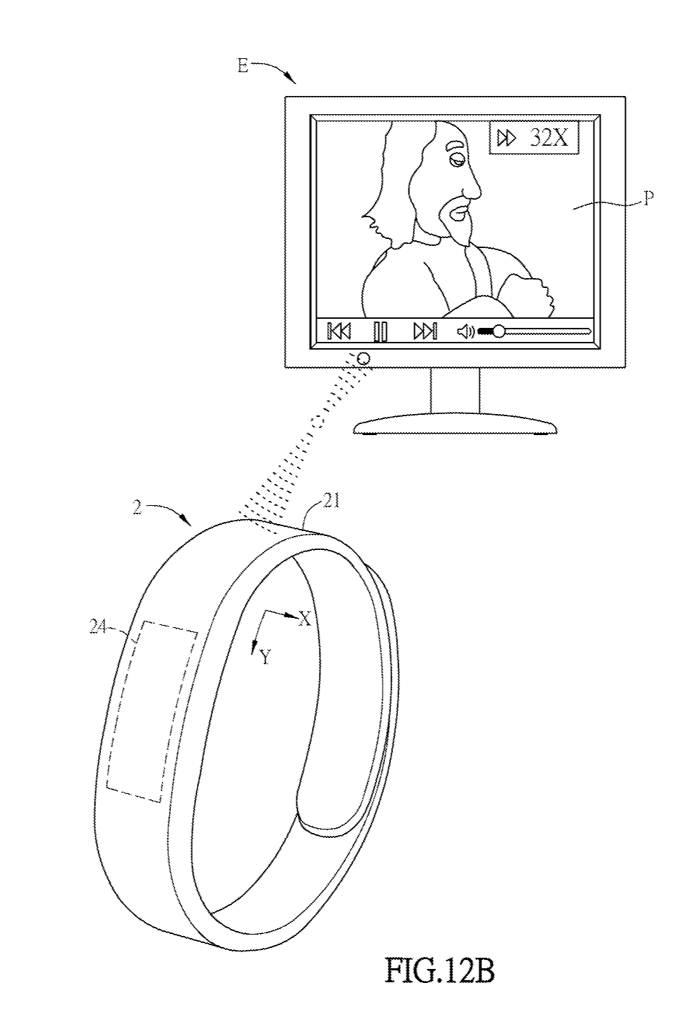

FIG. 10 is a schematic view showing operations of the smart strap of FIG. 7. Referring to FIGS. 8 and 10. The smart strap 2 of this embodiment can communicate with another electronic device E via the wireless module 22. The processing unit 23 is coupled to the wireless module 22 and the slide-on-strap touch-sensing structure 24. The processing unit 23 can receive the signal, when the slide-on-strap touch-sensing structure 24 is touched for inputting, the generate the corresponding operation instruction, transmit the operation instruction to the wireless module 22, and then communicate with the electronic device E via the wireless module 22, so that the display P of the electronic device E can display the corresponding operation instruction according to the gesture or posture (or the hand gesture or posture pattern) of the user's operation, and interact with the graphic user interface displayed on the display P to remotely control the electronic device E having the display P. The manipulation details may be found in the smart slide-on-strap device 1 of the first embodiment. In the following, the manipulations of the volume (see FIGS. 11A and 11B) and the playback speed (FIGS. 12A and 12B) of the electronic device E are directly described as an example.

FIGS. 11A and 11B are schematic views showing operations of the smart strap of FIG. 7. Referring to FIGS. 8, 11A and 11B. In one embodiment, it is possible to set the condition, in which when the electronic device E is turned on or being booted, the trigger event occurs on the slide-on-strap touch-sensing structure 24, the trigger time is longer than or equal to a preset predetermined time, and the trigger track contains one direction (i.e., the touch track path substantially is a straight line in one direction), the processing unit 23 produces the operation instruction for increasing or decreasing the volume, and remotely controls the electronic device E to execute the operation instruction for increasing or decreasing the volume via the wireless module 22. In this embodiment, the trigger track sliding from the region A (left) to the region B (right) in the X direction is defined as the operation gesture for increasing the volume; and the trigger track sliding from the region B (right) to the region A (left) in the X direction is defined as the operation gesture for decreasing the volume. For example, as shown in FIG. 11A, when the user touches the slide-on-strap touch-sensing structure 24 continuously for 1 second and the touch trigger track path slides from the region A (left) to the region B (right) in the X direction, the processing unit 23 produces the operation instruction for increasing the volume, and remotely controls the electronic device E to increase the volume via the wireless module 22, as shown in the volume region of FIG. 11B, wherein the black portion is increased. When the touch trigger track is executed on the contrary, the operation instruction for decreasing the volume is generated.

In one embodiment, it is also possible to set the operation instruction for increasing or decreasing the playback speed additionally. FIGS. 12A and 12B are another schematic views showing operations of the smart strap of FIG. 7. Referring to FIGS. 8, 12A and 12B. In details, it is possible to set the condition, in which when the user touches the slide-on-strap touch-sensing structure 24 continuously for 1 second, and the touch track path slides from the region C (up) to the region D (down) in the Y direction, such the touch gesture is defined as increasing the playback speed, and each gesture of operating from top to bottom may be defined as increasing the current playback speed by 2 times of speed. So, the 32 times of speed of FIG. 12B correspond to the gesture of the user of performing five sliding operations from top to bottom (the operations sequentially correspond to 2, 4, 8, 16 and 32 times of speed). Contrarily, when the user touches the slide-on-strap touch-sensing structure 24 continuously for 1 second, and the touch track path slides from the region D (down) to the region C (up) in the Y direction, such the touch gesture is defined as decreasing the playback speed.

In one embodiment, a central line may also be defined on the surface of the strap 21 to divide the slide-on-strap touch-sensing structure 24 into two touch-sensing areas (see the region A and the region B of FIG. 11A, or the region C and the region D of FIG. 12A) to simulate functions of two physical buttons of the mouse (e.g., the ENTER button for confirmation), so that more touch input methods and their corresponding operation instructions can be defined on the smart strap 2.

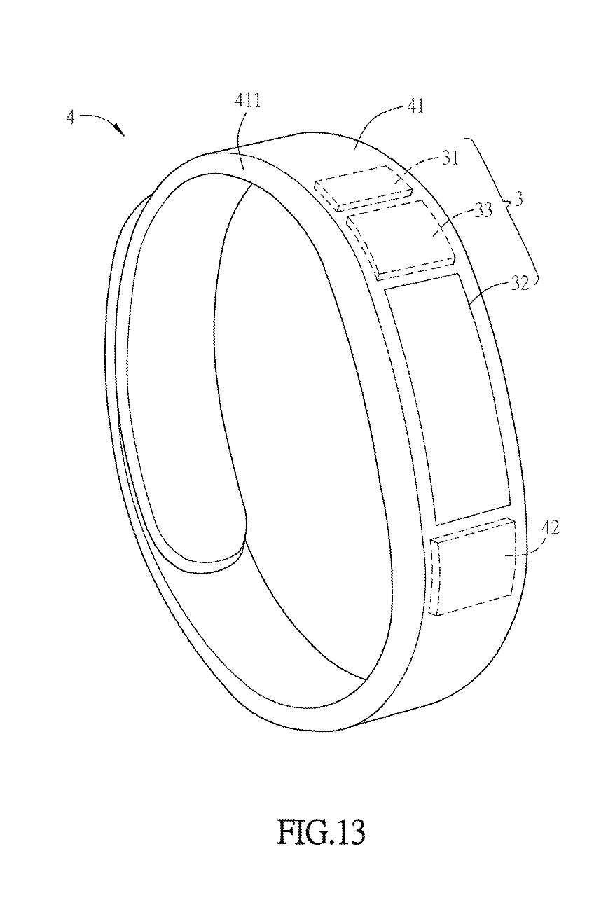

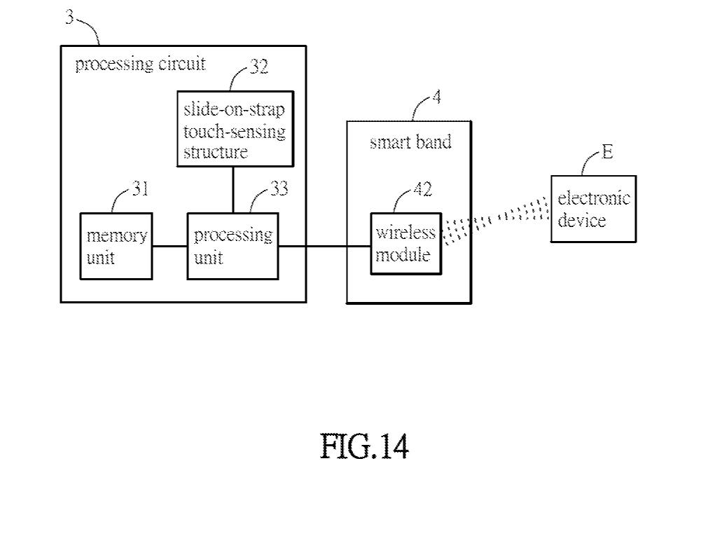

In addition, a processing circuit can be applied to the smart slide-on-strap device or the smart strap. FIG. 13 is a schematic view showing a processing circuit of a smart strap applied to the smart strap according to a third embodiment of the invention. FIG. 14 is a schematic block diagram showing the processing circuit and the smart strap of FIG. 13. Referring to FIGS. 13 and 14, a processing circuit 3 of this embodiment is disposed on a smart strap 4, which is a smart watch in one example. Elements of the smart strap 4 may be implemented by the processing circuit 3 and the combinations of the hardware, software, and firmware of other signal processing and/or integrated circuit or circuits. In details, the processing circuit 3 is disposed on a strap 41 of the smart strap 4, and the smart strap 4 further has a wireless module 42 coupled to the processing circuit 3.

The processing circuit 3 of this embodiment comprises a memory unit 31, at least one slide-on-strap touch-sensing structure 32 and a processing unit 33. The memory unit 31 stores at least one operation instruction, which is defined in correspondence with the touch input method of the user. The slide-on-strap touch-sensing structure 32 is disposed on the strap 41, and the user can perform the touch input on the slide-on-strap touch-sensing structure 32 so that the slide-on-strap touch-sensing structure 32 can correspondingly sense at least one trigger event. The processing unit 33 is coupled to the memory unit 31 and the slide-on-strap touch-sensing structure 32, so that the signal, generated according to the trigger event by the slide-on-strap touch-sensing structure 32, can be transmitted to the processing unit 33. The processing unit 33 analyzes the trigger event and performs the cache in the memory unit 31 to find the operation instruction corresponding to the trigger event. Additionally, as show in FIG. 14, the processing unit 33 is coupled to the wireless module 42 of the smart strap 4, so that the operation instruction can be transmitted to the electronic device E via the wireless module 42, and the user can remotely control the electronic device E by the processing circuit 3 and the smart strap 4.

The memory unit 31 of this embodiment may serve as a storage medium of the processing circuit 3, and the memory unit 31 stores multiple operation instructions. As mentioned hereinabove, the operation instruction is defined in correspondence with the trigger event induced by the user's touch input. As mentioned hereinabove, the trigger event may comprise the trigger quantity, the trigger quantity distribution, the trigger morphology, the trigger time, the trigger frequency or the trigger location, induced by the user's touch on the slide-on-strap touch-sensing structure 32, and the operation instructions corresponding to various trigger events can be preset when the processing circuit 3 (or smart strap 4) is shipped out, and the operation instructions are stored in the memory unit 31. In other embodiments, the operation instructions corresponding to various trigger events may also be modified by the users according to different using habits of various users, and may be stored in the memory unit 31. In other embodiments, the memory unit 31 may also serve as the random access memory of the smart strap 4, and may also store the operation system, the application program and the data processing program and the like, and executes the operation system, the application program and the data processing program through the processing unit 33. However, it is not limited thereto.

The slide-on-strap touch-sensing structure 32 of this embodiment is disposed on the strap 41, which may be worn by the user. So, in other embodiments, when the smart strap 4 is applied to the smart watch, the strap 41 may also be the watchband of the smart watch. However, it is not limited thereto. The slide-on-strap touch-sensing structure 32 may be disposed on the outer surface of the strap 41, so that the user can perform the touch input on the slide-on-strap touch-sensing structure 32 on the outer surface of the strap 41. Because the user can perform the touch input through the gesture with single-point or multi-point touch, sliding or the like, this embodiment is named as the slide-on-strap touch-sensing structure 32.

The number of the slide-on-strap touch-sensing structure(s) 32 is not limited, and it may be disposed on the strap 41 (e.g. on a surface of the strap 41 or a side edge 411 of the strap 41) at any position(s) for the user to perform the touch input to enlarge the area wherein the user executes the operation. However, it is not limited thereto. The slide-on-strap touch-sensing structure 32 of this embodiment may be understood with reference to the slide-on-strap touch-sensing structure 14 of the first embodiment, and detailed descriptions thereof will be omitted. The operation methods of the processing circuit of this embodiment applied to the smart strap may be understood with reference to the smart strap 2 of the second embodiment, and detailed descriptions thereof will be omitted.

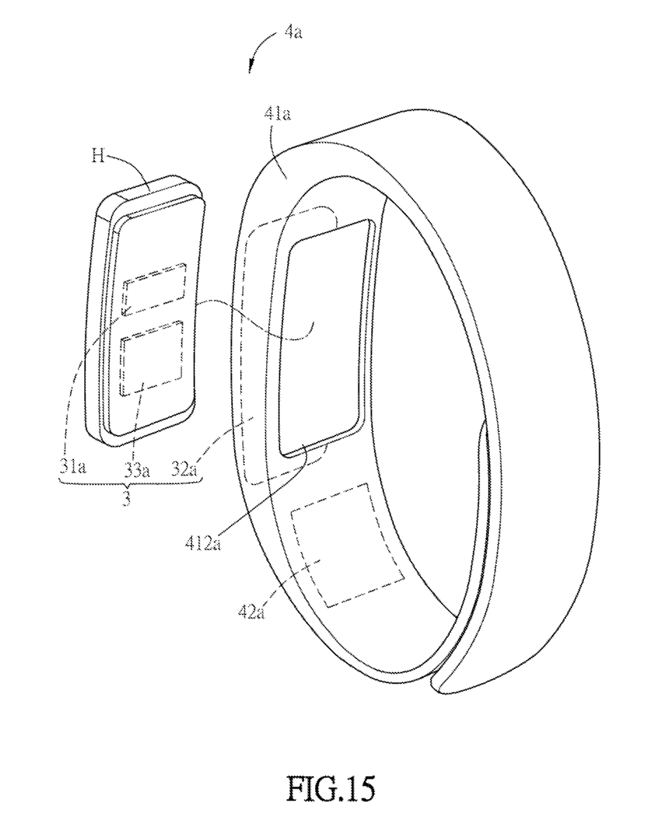

In addition, the processing circuit 3 of this embodiment is disposed on the strap 41, the memory unit 31 and the processing unit 33 are disposed inside the strap 41, and the slide-on-strap touch-sensing structure 32 is disposed on the outer surface of the strap 41. The memory unit 31 and the processing unit 33 are detachably or non-detachably disposed inside the strap 41. As shown in FIG. 13, the memory unit 31 and the processing unit 33 of this embodiment are non-detachably disposed inside the strap 41. In other embodiments, as shown in FIG. 15, FIG. 15 is a schematic view showing the processing circuit of the smart strap of the third embodiment applied to another example of the smart strap. A memory unit 31a and a processing unit 33a may be detachably disposed inside a strap 41a. In details, the memory unit 31a and the processing unit 33a may be accommodated within a housing H; the strap 41a has a slot 412a for accommodating the housing H so that the memory unit 31a and the processing unit 33a are detachably disposed inside the strap 41a; and a slide-on-strap touch-sensing structure 32a is still disposed on the outer surface of the strap 41a so that the user can perform the touch input.

In summary, the smart slide-on-strap device and the smart strap can be adopted for the user to perform input by touching the slide-on-strap touch-sensing structure disposed on the strap. In addition, because the memory unit in the processing circuit of the smart strap stores the operation instruction, and the slide-on-strap touch-sensing structure is disposed on the strap, the user can perform the touch operation on the slide-on-strap touch-sensing structure. Next, the processing unit produces the corresponding operation instruction, and the wireless module transmits the operation instruction to another electronic device having the display to remotely control the electronic device. In other words, the smart slide-on-strap device and the smart strap may be utilized as the smart remote controller to enhance the functions possessed by the smart slide-on-strap device and the smart strap. The design of the slide-on-strap touch-sensing structure may also need no more physical buttons and the overall integrity of the outlook of the slide-on-strap touch-sensing structure can be enhanced. In addition, because the element of performing the touch operation is almost on the slide-on-strap touch-sensing structure, the conventional physical button can be replaced, and the overall integrity and beauty of the outlook of the smart slide-on-strap device can be achieved, and the higher quality and more wonderful user experience can be implemented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A smart slide-on-strap device, comprising:
a body, having a strap;
a wireless module, disposed on the body;
a processing unit, coupled to the wireless module; and
at least one slide-on-strap touch-sensing structure, disposed on the strap and coupled to the processing unit, and sensing at least one trigger event to remotely control an electronic device having a display.

2. The smart slide-on-strap device of claim 1 comprising a smart bracelet, a smart watch or a smart remote controller.

3. The smart slide-on-strap device of claim 2, wherein the strap comprises a watchband of the smart watch or a strap of the smart bracelet.

4. The smart slide-on-strap device of claim 1, wherein the processing unit receives a signal generated according to the trigger event and correspondingly produces an operation instruction.

5. The smart slide-on-strap device of claim 4, wherein the wireless module receives and transmits the operation instruction to the electronic device having a display.

6. The smart slide-on-strap device of claim 1, wherein the trigger event comprises a trigger quantity, a trigger quantity distribution, a trigger morphology, a trigger time, a trigger frequency or a trigger location.

7. The smart slide-on-strap device of claim 6, wherein if the trigger event occurs on the slide-on-strap touch-sensing structure, the trigger time is longer than or equal to a predetermined time, and a trigger track corresponds to one direction, then the processing unit produces an operation instruction of increasing or decreasing a volume.

8. The smart slide-on-strap device of claim 6, wherein if the trigger event occurs on the slide-on-strap touch-sensing structure, the trigger time is longer than or equal to a predetermined time, and a trigger track corresponds to one direction, then the processing unit produces an operation instruction of increasing or decreasing a playback speed.

9. The smart slide-on-strap device of claim 6, wherein if the trigger event occurs on the slide-on-strap touch-sensing structure, the trigger track comprises multiple trigger tracks having more than one direction, then the processing unit produces an operation instruction of one-dimensional screen scrolling, wherein a direction of the one-dimensional screen scrolling is the same with the direction of multiple trigger tracks.

10. The smart slide-on-strap device of claim 6, wherein if the trigger frequency of the trigger event conforms to a booting condition, then the processing unit produces an operation instruction of booting.

11. The smart slide-on-strap device of claim 1, wherein the wireless module comprises an infrared module, a bluetooth module, a ZigBee module, a radio frequency module or a near-field communication module.

12. The smart slide-on-strap device of claim 11, wherein the near-field communication module comprises a user identification key automatically linking to the electronic device having a display through the wireless module.

13. The smart slide-on-strap device of claim 1, wherein the wireless module has a wireless communication chip and an antenna, the wireless communication chip is electrically connected to the processing unit, and the antenna is disposed on the body or the slide-on-strap touch-sensing structure.

14. The smart slide-on-strap device of claim 1, wherein the wireless module synchronously or asynchronously transmits a wireless signal and receives wireless charging energy of a wireless charging device.

15. The smart slide-on-strap device of claim 14, wherein the wireless charging energy comes from a wireless access point, a display, a television or a monitor.

16. The smart slide-on-strap device of claim 1, wherein the slide-on-strap touch-sensing structure comprises a driving circuit and a sensing circuit, the driving circuit is disposed inside the strap, and the sensing circuit is disposed on an outer surface of the strap.

17. The smart slide-on-strap device of claim 16, wherein a portion of the sensing circuit on the outer surface of the strap has a protrusion, and the strap further comprises a protection layer covering the protrusion.

18. A smart strap, comprising:
a strap;
a wireless module disposed on the strap;
a processing unit coupled to the wireless module; and
at least one slide-on-strap touch-sensing structure, disposed on the strap and coupled to the processing unit, and sensing at least one trigger event to remotely control an electronic device having a display.

19. The smart strap of claim 18, wherein a central line is disposed on a surface of the strap to divide the slide-on-strap touch-sensing structure into two touch-sensing areas to simulate functions of two physical buttons of a mouse.

20. A processing circuit of a smart strap, the smart strap having a strap and a wireless module, the processing circuit being coupled to the wireless module, the processing circuit comprising:
a memory unit storing at least one operation instruction;
at least one slide-on-strap touch-sensing structure, disposed on the strap and sensing at least one trigger event; and
a processing unit, coupled to the memory unit and the slide-on-strap touch-sensing structure, receiving a signal generated according to the trigger event from the slide-on-strap touch-sensing structure, and correspondingly producing the operation instruction to remotely control an electronic device having a display.
